(19) United States
(12) Patent Application Publication
(10) Pub. No.: US 2006/0099482 A1
(43) Pub. Date: May 11, 2006

(54) Fuel cell electrode

(75) Inventors: Keith Scott, Newcastle (GB); Hua Cheng, Newcastle (GB)

Correspondence Address: PATTON BOGGS LLP, 8484 WESTPARK DRIVE, SUITE 900, MCLEAN, VA, 22102, US

(73) Assignee: Newcastle University Ventures Limited, Newcastle Upon Tyne (GB)

(21) Appl. No.: 10/525,815

(22) PCT Filed: Aug. 27, 2003
(86) PCT No.: PCT/GB03/03715

§ 371 Date: Aug. 8, 2005

(30) Foreign Application Priority Data
Aug. 28, 2002 (GB) 0219955.2

(51) Int. Cl. H01M 8/00; H01M 4/86

(52) U.S. Cl. 429/40; 429/13

(57) ABSTRACT

A fuel cell (1) having an electrode comprising an electrocatalyst (32) on a support, wherein the support is a mesh (30) of conductive material such as a metal, metal alloy and metal composite (e.g. titanium or titanium alloy), is disclosed, as well as a method of operating such a fuel cell by contacting a fuel and an oxidant on said electrode. The electrolyte of the fuel cell may be an ion exchange membrane.

### FIELD OF THE INVENTION

The invention relates to fuel cells and in particular to electrodes for use in fuel cells.

### BACKGROUND TO THE INVENTION

Fuel cells convert the chemical energy of a fuel into electrical energy. A fuel cell comprises an anode, a cathode and an electrolyte separating the anode and cathode. A fuel cell has an inlet or anode compartment for delivering fuel to the anode and an inlet or cathode compartment for delivering oxidant to the cathode. The simplest fuel cell is one in which hydrogen is oxidised to form water over, for example, nickel electrodes. Oxygen gas is delivered to the cathode where it is reduced to produce hydroxide ions, and hydrogen is delivered to the anode where it is oxidised to produce water. The nickel acts as a catalyst. Electrons flow through an external circuit connecting the anode and cathode, thereby generating an electric current.

Fuel cells have a number of advantages over other power generating technologies, for example they are generally more efficient than combustion engines, they have low emissions where hydrogen is the fuel and they have few, if any, moving parts resulting in very quiet operation.

In a conventional hydrogen fuel cell, the hydrogen reacts at the anode, releasing energy. However, there are a number of drawbacks associated with hydrogen fuel cells, for example hydrogen is a gas and difficult and expensive to store, and is not a readily available fuel source. To increase the rate of reaction of hydrogen, the surface area of the electrode and the operating temperature of the cell can be increased and a catalyst can be used. A number of fuel cell technologies are known including proton exchange membrane fuel cells (PEM), alkaline fuel cells, acid fuel cells phosphoric acid fuel cells (PAFC), solid oxide fuel cells (SOFC) and molten carbonate fuel cells (MCFC).

Liquid feed fuel cells are attractive alternatives to hydrogen fuel cells for static/portable power and transportation applications and avoid the problems associated with transporting and storing hydrogen gas. Fuels such as methanol, ethanol, and dimethyl ether can be used in liquid feed systems. In operation liquid feed fuel cells oxidise the fuel directly at the anode and release carbon dioxide. The fuel is typically present in aqueous solution, such as in a direct methanol liquid feed fuel cell (DMFC).

An example of a reaction carried out in known fuel cells is the oxidation of methanol in a DMFC under alkaline conditions:
1.5O₂+3H₂O+6e⁻→6OH⁻ (Ia) Cathode:
CH₃OH+6OH⁻→CO₂+5H₂O+6e⁻ (Ib) Anode:

A second example is the oxidation of methanol under acidic conditions:
1.5O₂+3H⁺+6e⁻→3H₂O (IIa) Cathode:
CH₃OH+H₂O→CO₂+6H⁺+6e⁻ (IIb) Anode:

In these examples the overall reaction is:
CH₃OH+1.5O₂→CO₂+2H₂O (III)

In this reaction CO₂ is released at the anode.

### SUMMARY OF THE INVENTION

The present inventors have identified a problem with electrode structures in known fuel cells. Conventional electrode structures suffer from poor diffusion of reaction products away from the electrode surface, and this makes it difficult for fuel to reach the electrode surface. Put simply, the products or by-products of the electrochemical reaction at the electrode surface are not efficiently removed and therefore hinder the influx of fuel. This problem is particularly acute where the product is a gas because a build up of gas on the electrode surface presents a significant barrier to the influx of liquid fuel. In particular the formation of CO₂ gas at the anode in known hydrocarbon based fluid fuel cells, such as a DMFC, blocks access of the hydrocarbon based fuel to the anode surface which reduces the effectiveness of the catalyst and increases the anode resistance. A further problem with conventional fuel cells having an electrolyte membrane separating the anode and cathode is that gas bubbles produced at the electrodes adhere to the membrane and further increase the cell resistance.

Conventional fuel cell electrodes essentially comprise a series of layers: a supported catalyst layer, a PTFE bonded carbon black diffusion layer, and a carbon cloth or paper diffusion layer. The present inventors have found that this electrode structure is not ideal for the transport and release of gas or other product from an electrode and can result in considerable hydrodynamic and mass transport limitations for the fuel at the anode. In other words, the known fuel cell electrode structures do not allow gas or other products to be removed efficiently from the electrode surface. The present inventors have discovered that this is a particular problem with conventional anode structures.

This leads to significant electrode polarisation or voltage drop. Indeed the extent of electrode polarisation, that is the overvoltage which reduces or works against the reversible ideal voltage at the electrode, is a useful measure of the mass transport problem of conventional fuel cells.

The present inventors have addressed this problem by providing fuel cells having a mesh electrode structure.

In a first aspect, the present invention provides a fuel cell having an electrode comprising an electrocatalyst on a support, wherein the support is a mesh of conductive material.

In a second aspect, the present invention provides a method of operating a fuel cell comprising the step of contacting a fuel and an oxidant on an electrode comprising an electrocatalyst supported on a mesh of conductive material.

In a third aspect, the present invention provides the use of an electrode comprising an electrocatalyst supported on a mesh of conductive material in a fuel cell.

The following comments, definitions and preferred features apply to all aspects of the present invention.

The present invention is particularly concerned with mesh anode structures.

Fuel Cell

A fuel cell according to the present invention is a galvanic cell in which the oxidation of fuel is utilized to produce electricity. More specifically the oxidation of fuel occurs at an electrode, generating a current in the electrode. A fuel cell suitably comprises an anode and a cathode, and one or both of the anode and cathode will be an electrode of the present invention. Preferably the electrode of the present invention functions as an anode during operation of the fuel cell. In use the fuel cell comprises an electrolyte separating the anode from the cathode. Therefore the fuel cell preferably comprises an electrode and an electrolyte. Preferably the electrolyte is a membrane electrolyte, and this is discussed below. In use the fuel cell will also comprise an electric circuit connecting the anode to the cathode and so preferably the fuel cell comprises an electric circuit connecting the anode to the cathode. Oxidation of a fuel at the anode and reduction of an oxidant at the cathode generates an electric current in the external circuit.

The fuel cell may be a divided fuel cell which has separate compartments for fuel and oxidant, called anode and cathode compartments, or an undivided fuel cell in which fuel and oxidant are mixed in a single compartment.

Where the cell comprises a single compartment in which fuel and oxidant are mixed, the anode and cathode may be in direct electrical contact or contacted externally at the electrode periphery. Alternatively, the anode and cathode can be in electrical contact as part of a bipolar electrode. A bipolar electrode typically comprises a conducting support with an anode and a cathode layer deposited on opposite sides. In an embodiment of the present invention the support is a mesh of conductive material.

In a fuel cell comprising an anode and a cathode compartment, the two compartments each provide a reservoir of fuel or oxidant and are suitably designed to deliver the fuel or oxidant to the anode or cathode respectively. Suitably, there is a large contact area between the anode or cathode and the fuel or oxidant. It is further preferred that the anode and cathode form at least a part of one wall of the anode and cathode compartment respectively, thereby enabling the fuel and/or oxidant to reach the electrodes.

In a fuel cell comprising an anode and cathode compartment, the fuel cell may also comprise an additional central compartment which separates the anode compartment from the cathode compartment.

In both divided and undivided fuel cells the compartment or compartments will typically be sealed or gas-tight so that gaseous or volatile liquid fuels can be used therein. Suitably the electrode compartments have at least one inlet for receiving fuel and/or oxidant. There may be separate inlets for fuel and oxidant. The fuel and oxidant may be mixed together before entering the cell or mixed together inside the fuel cell. The fuel cell comprises at least one outlet for carrying away spent fuel, products and by-products of the reaction. In the case where the cell has an anode and a cathode compartment, each compartment may have at least one inlet and at least one outlet. Thus a fuel cell of the present invention may comprise a sealed electrode compartment, for use with gaseous substrates or volatile liquids, having an inlet and an outlet. The inlet and/or outlet may contain valves for directing fluids into and out of the electrode compartment and preventing back flow. In a preferred arrangement the fuel cell comprises an anode compartment, a cathode compartment and a membrane electrolyte.

The fuel cell may comprise a plurality of electrode structures so that a plurality of working anode-cathode pairs may operate within a single fuel cell. For example, the cell may comprise a plurality of membrane electrode assemblies (described below) which are connected by bipolar plates or by external connections connected to the periphery of the electrodes.

The fuel cell may contain a heater for heating the fuel cell, and in particular the electrode compartment, to increase the rate of reaction at the electrodes and/or to volatilise the fuel. Suitably the heater will be capable of heating the fuel cell in the range 30−300° C. and preferably in the range 30−200° C., during operation. The heater may be an integral heater and may be located within the body of the fuel cell or even within the electrode compartment.

The fuel cell may be capable of operating at an elevated pressure, for example where an over pressure of air is used to increase the concentration of oxygen in the fuel cell. The fuel cell may operate at 0.1−20 MPa, preferably 0.1−10 MPa and most preferably 0.1−5 MPa.

The fuel cell can be a stationary cell or a rotary cell, i.e. a fuel cell which can be rotated or spun, for example in a centrifuge, to generate a centrifugal field. In a rotary fuel cell the rotation generates centrifugal forces which assist gas movement from the surface of the electrode which can improve performance.

The fuel cell may be one of several types known to those skilled in the art, for example a proton exchange membrane fuel cell (PEM), alkaline fuel cell, acid fuel cell, phosphoric acid fuel cell (PAFC), solid oxide fuel cell (SOFC) or molten carbonate fuel cell (MCFC).

The Fuel

The fuel cell of the present invention operates with liquid or gaseous fuels and oxidants. The fuel cell may be used where there is a liquid feed only or where a liquid is introduced with a gas or vapour, or produced by a reaction, e.g. from oxygen reduction at the cathode. Examples of a liquid fuel include hydrocarbons such as methanol, dimethyl ether, dimethoxy methane, trimethoxymethane, formaldehyde, trioxane, ethylene glycol, dimethyl oxalate, methylene blue, formic acid, methanol and ethanol or inorganic fuels such as sodium borohydride or similar hydrides. Examples of gaseous fuels include hydrogen, methane, ethane, propane, chlorine, carbon monoxide and higher hydrocarbons.

Examples of oxidants include oxygen, hydrogen peroxide, organic peroxides, inorganic species such as ferroxy amides, aqueous salt solutions containing higher oxidation state metals such as vanadium, chromium, iron, etc, and halogens.

The physical state of the fuel inside the fuel cell, where it reacts at the electrodes, may be different from the physical state of the fuel as it enters the fuel cell. For example a methanol solution can be vapourised before entry into the cell or supplied at a temperature and pressure such that vaporisation takes place within the cell. The fuel may also be a vapour under normal temperature and pressure. Typically, the fuel cell operates at elevated temperatures and so a liquid fuel entering the cell may be partly vaporised before it reacts at the electrode inside the cell. Reference to liquid fuels or gas fuels herein is a reference to the fuel as it enters the fuel cell, as opposed to the fuel at the electrode.

Mesh

The mesh of the present invention is an open porous structure comprising a lattice or network of wires, fibres or strands. The wires, fibres or strands define pores or openings and the mesh has a minimum pore size of 5 μm. Preferably the minimum pore size is 10 μm, more preferably 20 μm and most preferably 50 μm.

Typically the mesh comprises one or more layers, each layer comprising a first set of strands, fibres or wires interleaved or overlaid by a second set of strands, fibres or wires. Each layer may be for example a grid or gauze. Preferably the mesh comprises a plurality of grids. Preferably the mesh comprises a plurality of layers, each layer being oriented at an angle, or offset, with respect to adjacent layers. Preferably adjacent layers are substantially at right angles. The layers may be joined together by strands, fibres or wires, which strands, fibres or wires suitably extend substantially perpendicular to the layers; these strands, fibres or wires define further pores or openings in the mesh. The layers may also be joined together by an electrically conductive adhesive, bonding agent or solder.

The mesh therefore has a three-dimensional open cell structure comprising a network of interlinked channels which permit the movement of fluids, in particular gases, through the structure.

The mesh is a support for the electrocatalyst and also provides the electrode with structural integrity. Suitably it will act as a current collector.

The thickness of the wires, fibres or strands which make up the mesh is at least 5 μm. Preferably it is in the range 10 μm to 5 μm. More preferably the strand thickness is in the range 50 μm to 1 mm. Most preferably the strand thickness is in the range 50 to 500 μm. It is desirable to use a small strand size because a high surface area to weight and high surface area to volume ratio can be achieved. The shape of the strand, that is its cross section, may be any shape but will typically be rectangular, triangular or rhombus. The preferred strand thickness given above corresponds to the largest cross section dimension of the strand.

The pore size or opening size of the mesh is selected to allow the liquid and the gaseous products formed on the surface of the electrode to pass through the mesh. The pore size is at least 5 μm, and preferably in the range 5 μm to 1 mm. Preferably the pore size is in the range 50 μm to 500 μm. More preferably the pore size is in the range 75 μm to 200 μm.

A combination of small pore size and small strand size is preferred because this provides optimum surface area with respect to the weight or volume of the mesh, allowing the size of the electrode to be minimised. Fuel cells of the present invention find application in portable or moveable devices and so a reduction in size or weight is advantageous.

An alternative way of defining the dimensions of the pores and the strands is the “mesh” or number of apertures per inch. The mesh support of the present invention is at least 10 mesh, preferably at least 20 mesh, more preferably at least 40 mesh. The mesh support preferably has a mesh of less than 200. It is preferred that the mesh of the present invention is in the range 20 to 100 mesh. This corresponds to a pore size range of 1 mm−50 μm if the wire diameter is 0.2 mm.

A preferred mesh structure is a mini-mesh. A mini-mesh means a mesh structure with a mesh size of larger than about 30 mesh, i.e. a pore size of less than about 640 μm if the wire diameter is 0.2 mm.

The high surface area of the mesh ensures that electrode surface area is available for adsorption and reaction of the fuel even at high gas production rates. The large free volume of the mesh allows gas bubbles formed on the surface of the mesh to escape from the electrode, even when the surface is an internal surface. As used herein the term free volume means the volume within the mesh structure not occupied by strands, fibres or wires.

The mesh of conductive material, and particularly metal meshes, is a physically stable and self supporting structure formed without any binders.

The mesh of the present invention is made from a conductive material which permits the flow of electrons to generate an electric current in the mesh. The mesh may be made of any conductive material including metal, metal alloys, and metal composites. Examples of preferred conductive material include Ti, Ti/Ni, Ti/Cr, Ti/Cr/Ni, Ta, Ni, Cr, Al, carbon, and stainless steel. The mesh may comprise oxides or nitrides, for example TiO₂ and TiN. The mesh is exposed to corrosive materials during operation of the fuel cell and so preferably the mesh is made from a corrosion resistant material, such as Ti or Ti alloy. Preferably the material is a refractory material, permitting operation of the fuel cell at elevated temperatures.

The mesh may be coated with a layer of for example Pt or Au, to improve the corrosion resistance of the mesh and to provide improved adhesion between the mesh and the electrocatalyst. A thin coating layer may be applied by for example, electrodeposition or chemical (electroless) deposition.

The overall shape of the mesh, and hence the electrode, depends on the requirements of the fuel cell in which the electrode is used. Typically the mesh will be a flat mesh, which can be easily attached to a membrane electrolyte to form a membrane electrode assembly. Alternatively, the mesh may be contoured, for example a corrugated mesh. The mesh may also be a spiral wound mesh to form a cylindrical body, which may be desirable for use in a rotary cell. The electrode support may also be formed from a combination of capillary shaped meshes. Such geometries can improve the electrode area per unit volume and the energy density of the fuel cell. The mesh support may be formed from a body of mesh, by cutting and shaping to the desired size and shape.

The configuration of the fuel cell will typically comprise flat mesh electrodes and membranes arranged, for example, in parallel. Alternatively, electrodes and polymer membranes may be arranged in a spiral as mentioned above, to form a compact cylindrical fuel cell.

The thickness of the mesh will be dictated by the size and requirements of the fuel cell. Typically the mesh will have a thickness of less than about 5 mm, preferably less than about 1 mm.

Electrocatalyst

The electrocatalyst is a material that catalyses the oxidation or reduction of a fuel or oxidant at an electrode in a fuel cell. The term oxidation as used herein means an electrochemical reaction performed on a substrate whereby the substrate loses electrons. Conversely, the term reduction as used herein means an electrochemical reaction performed on a substrate whereby the substrate gains electrons. Typically the electrocatalyst is a metal, metal alloy, metal oxide or metal hydride. Examples of an electrocatalyst are Au, Pt, Pt/Ru, Pt/Ru/Ir, Pt/Sn, Pt/Sn/Ru, Ru/Se, Ta, W, Rh, Mo, Co, Fe, Pd, Ni, Mn, and Ag oxides. The nature of the electrocatalyst will depend on whether the reaction to be catalysed is an oxidation or reduction reaction and on the nature of the fuel and oxidant, since this dictates the catalytic activity that is required. For example, Pt and/or Au are preferably used for the oxidation of the fuel where the fuel is sodium borohydride, or other hydrides. Alternatively, where the fuel is dimethyl ether, dimethoxy methane, trimethoxymethane, formaldehyde, trioxane, ethylene glycol or dimethyl oxalate under alakaline conditions the electrocatalyst is preferably selected from Pt, Pd, Mn, Ni and Ag oxides. In acidic conditions, where the fuel is formic acid, methanol or ethanol, the electrocatalyst is preferably selected from Pt, Pt/Ru, Pt/Ru/Ir, Pd, Pt/Sn, and Pt/Sn/Ru.

Where the electrocatalyst catalyses the reduction of the oxidant, for example oxygen, at the cathode it may be selected from Pt, Pt/Co, Pt/Ni, Pt/Cr, Pt/Fe, Pt/Co/Cr, Pd, Ag, Ni, Ru or Ru/Se.

The electrocatalyst may also comprise a co-catalyst to improve activity or selectivity of the chemical reaction at the electrode. Examples of a co-catalyst include Ir, Rh, Os, Co and Cr.

The electrocatalyst is present as a layer or coating on the mesh support. Suitably, the electrocatalyst layer is present only on the strands of the mesh, leaving the pores and channels substantially uncovered.

The electrocatalyst is joined to the mesh directly or via one or more intermediate layers. Intermediate layers may improve the adhesion between the electrocatalyst and the mesh, or may facilitate joining of the electrocatalyst to the mesh where direct joining of electrocatalyst to mesh is not possible or unsatisfactory. A suitable intermediate layer may provide increased surface area on which to deposit the electrocatalyst compared with the surface of the mesh. For example a porous intermediate layer may provide an increased surface area on which to deposit the electrocatalyst thereby increasing the available surface area of the catalyst. Examples of materials used to make suitable intermediate layers include Au, Pt, Ni and Cu. The electrocatalyst may be joined to the mesh or intermediate layer by chemical bonds and/or a physical interaction between the two materials.

The electrocatalyst layer is formed on the mesh or intermediate layers by applying the electrocatalyst directly by known methods, for example by physical methods such as applying a paste or suspension containing the catalyst, or by deposition such as electrodeposition, chemical deposition, thermal oxidation, thermal reduction or chemical vapour deposition (CVD).

Electrolyte

In use, the fuel cell comprises an electrolyte. An electrolyte is a medium that conducts electricity by permitting passage of charged species, such as ions, but not electrons. The electrolyte may be anion conducting and/or cation conducting. The electrolyte is located between the anode and cathode and separates the two electrodes. Suitably the anode and cathode are immediately adjacent the electrolyte. It allows charged species, except electrons, to pass from one electrode to the other. It may also be permeable to neutral species. The electrolyte may be a liquid or a solid. The electrolyte may be selective in that it is permeable only to certain ions or neutral species. The electrolyte may be an ion exchange membrane such as a cation exchange membrane which will be cation conducting, or an anion exchange membrane which will be anion conducting. The ion exchange membrane can be any suitable material which allows the passage of at least one ion involved in the electrolytic processes at the anode and the cathode.

The membrane may be classified according to the type of ion transported, i.e.:

cation transfer—selective to the transport of positively charge ions, such as H⁺ or Na⁺;

anion transfer—selective to the transport of negatively charged ions, such as OH⁻, Cl⁻, O₂⁻, CO₃²⁻;

bipolar—can split water into H⁺ and OH⁻ by application of a potential difference across membrane.

The membrane can also be classified by its material, i.e. inorganic, organic or inorganic/organic composite.

Examples of organic membranes include, but are not limited to, those based on fluorocarbon, hydrocarbon or aromatic polymers with or without side chains, e.g. divinyl benzene with active exchange groups, such as sulphonate and carboxylate for cation exchange, and amine for anion exchange.

Particularly preferred organic membranes include Nafion, a fluorosulphonate ionmer, more particularly a perfluorosulphonic acid PTFE copolymer, and Fumatech FT-FKE-S, which has amine based exchange groups.

Examples of inorganic membranes include, but are not limited to, nano-porous membranes with an immobilised acid, e.g. SiO₂/PVDF binder/sulphuric acid.

Examples of organic/inorganic composite membranes include Nafion/phosphate, Nafion/silica and Nafion/ZrO₂.

The electrolyte may also be an immobilised or stationary electrolyte. Other suitable electrolytes include an immobilised ionic conductor and an aqueous electrolyte, including proton conducting, hydroxide conducting and alkali metal conducting electrolytes such as ionic liquids. The electrolyte may be a composite, a mixture of polymers, inorganic salts, acids or oxides. Another example of an electrolyte is a molten ionic compound in which ions can be dissolved. Preferably the electrolyte is a membrane, preferably a polymer membrane. Preferably the polymer membrane is a perfluorosulphonic acid PTFE copolymer such as Nafion or Fumatech FT-FKE-S.

The magnitude of the separation between the anode and cathode and hence the thickness of the electrolyte will depend on the size of the fuel cell. Typically the separation between the anode and cathode is small, and so the thickness of the electrolyte is also small. This has the advantage of reducing the resistance of the electrolyte. Typically the electrolyte has a thickness of less than 1 mm. More preferably the electrolyte has a thickness of less than 200 μm, and more preferably less than 100 μm. Preferably, the electrolyte is selected from the group consisting of a polymer electrolytic membrane, an immobilised ionic conductor and an aqueous solution. Where the electrolyte is a solid, for example a polymer membrane, the electrodes are typically attached directly to the electrolyte using, for example a hot pressing method. Alternatively the electrolyte can be physically held onto the electrodes.

In an embodiment a mini-mesh anode and cathode are attached to each other using a permselective ionomer coating of a fluorinated polymer, which is also the electrolyte.

The fuel cell electrode of the present invention may be used in a wide range of fuel cells, but has particular benefits in fuel cells where gas, and in particular CO₂, is generated at the electrode.

The fuel cell electrode of the present invention provide a reduction of mass transport limitations at the electrode surface compared to known fuel cell electrode structures.

The electrode structures promote and facilitate the release of oxidation products, in particular gas products, from the electrocatalyst on the surface of the electrode, thereby improving mass transport and reducing electrode polarisation or overpotential.

The electrode operates in any fluid medium, but is particularly useful for liquids such as water, acid and basic aqueous solution, organic solvents, ionic liquid and combinations thereof. The organic fuel in the case of a fuel cell is typically methanol, ethanol, dimethyl formate, ethers or other alcohols.

The mesh supported electrocatalysts of fuel cells of the present invention provide enhanced anode over-potential performance and facilitate improved gas evolution from the surface of the electrode during the oxidation of liquid fuels. This brings about improvements in fuel cell performance.

Additional benefits derived from the present invention include higher power densities and a more flexible operation resulting from the greater range of fuel concentrations that are accessible. Furthermore, the present invention provides a relatively simple electrode structure which can be fabricated using known expertise in the manufacture of meshes and coated electrode structures. The present invention also provides a more versatile cell design based on thin, lightweight metal components because the conductivity limitations of the carbon cloth and bipolar plate of conventional arrangements can be eliminated.

The present invention allows low fuel concentrations to be used. The benefits arising from this include reduced methanol crossover and thus reduced electrode polarisation, greater methanol conversion and reduced methanol content in the exhaust gas with subsequent improvements in energy efficiency and reduced environmental problems and system costs.

A preferred fuel cell according to the present invention is a DMFC comprising a divided cell having an anode compartment and a cathode compartment, separated by an electrode assembly. The anode and cathode compartments each have an inlet and an outlet. The electrode assembly comprises an anode and a cathode, separated by a membrane electrolyte. The anode comprises a metal mesh support coated with an oxidation electrocatalyst. The anode and cathode are bonded to opposite sides of the membrane electrolyte to form a membrane electrode assembly. The membrane electrolyte is a polymer electrolyte that is permeable to water, protons, and hydroxide ions. The anode and cathode are electrically connected via an external circuit.

In use the fuel, methanol, enters the anode compartment as an aqueous solution through the inlet, and passes over the anode. The oxidant, O₂, in the form of air enters the cathode compartment through the inlet and passes over the cathode. Water from the aqueous methanol solution passes through the membrane to the cathode where it reacts with O₂ and electrons from the cathode on the reduction electrocatalyst to generate hydroxide ions. The hydroxide ions migrate across the membrane in the opposite direction to the flow of water due to the hydroxide concentration gradient over the membrane. At the anode, methanol and hydroxide ions react on the oxidation electrocatalyst to generate water, CO₂ and electrons which flow into the anode. The CO₂ produced at the anode is able to diffuse away from the anode surface because of the mesh structure of the anode, thereby avoiding a build up of CO₂ at or near the active sites of the electrocatalyst. The continuous production of electrons at the anode and consumption of electrons at the cathode produces a flow of electrons between the electrodes in the external circuit, and an electric current is established. The water and hydroxide ion products of the two electrode reactions are themselves reactants, and CO₂ is an end product that takes no further part in the reaction chemistry. CO₂ is produced at the anode surface on the oxidation electrocatalyst supported on the mesh. The mesh structure prevents CO₂ from building up on the electrocatalyst because it allows the CO₂ to diffuse away from the catalyst active sites. CO₂ is removed from the anode compartment by its own buoyancy or the flow of fuel feed, and exits the compartment via the outlet. The oxygen depleted air in the cathode compartment is removed from the compartment by the constant inflow of fresh air.

The invention will now be described by way of example only with reference to the accompanying figures in which:

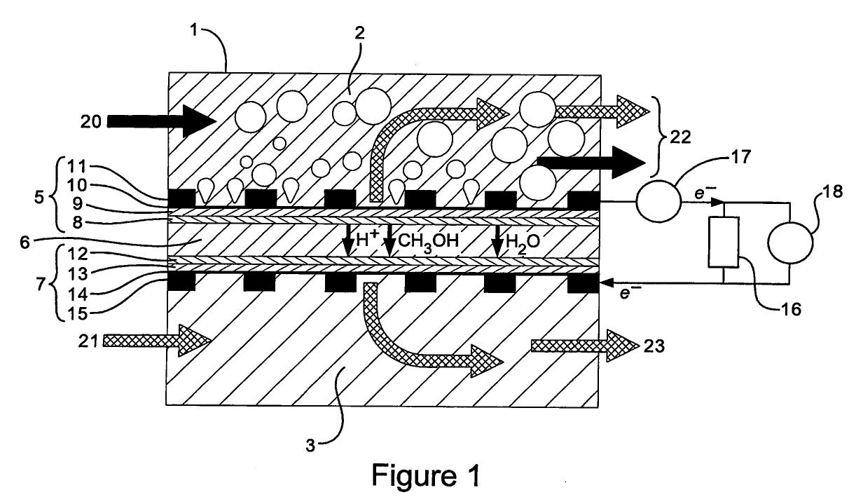

FIG. 1 is a schematic representation of a conventional direct methanol liquid feed fuel cell and is part of the prior art;

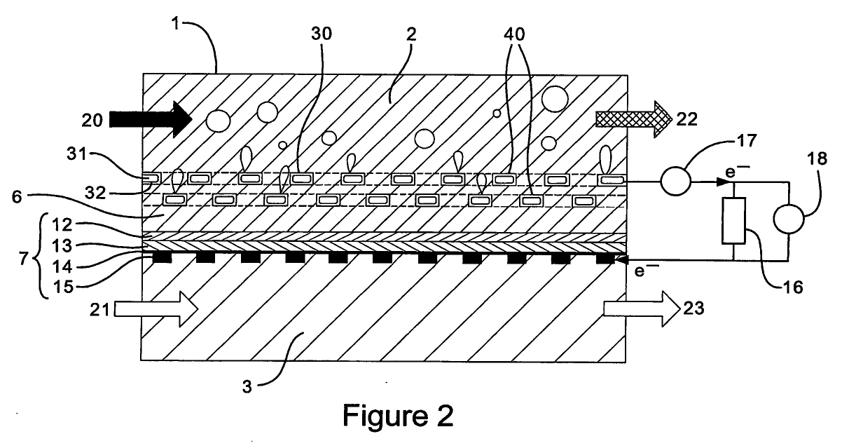

FIG. 2 is a schematic representation of a direct methanol liquid feed fuel cell having an electrocatalyst coated Ti mesh electrode and is a first embodiment of the present invention;

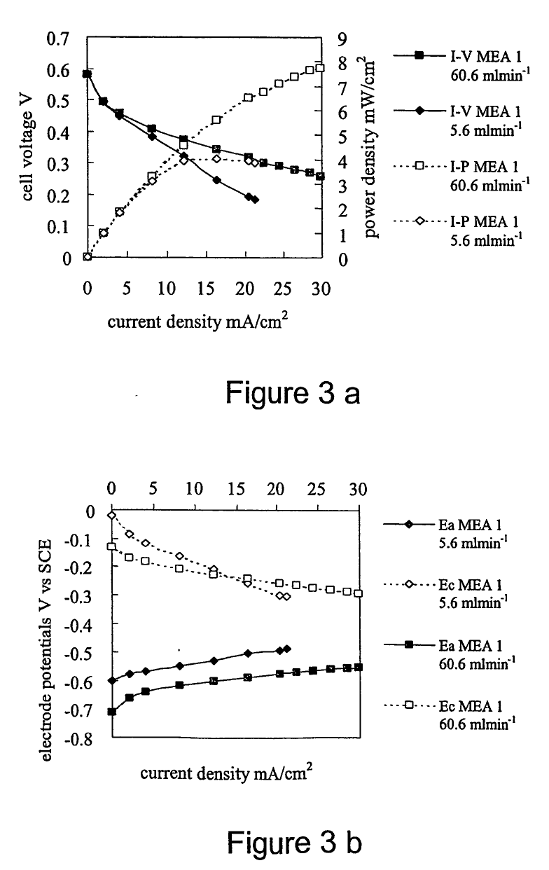

FIGS. 3a and 3b are graphs of the cell performance of an embodiment of the present invention at different fuel flow rates;

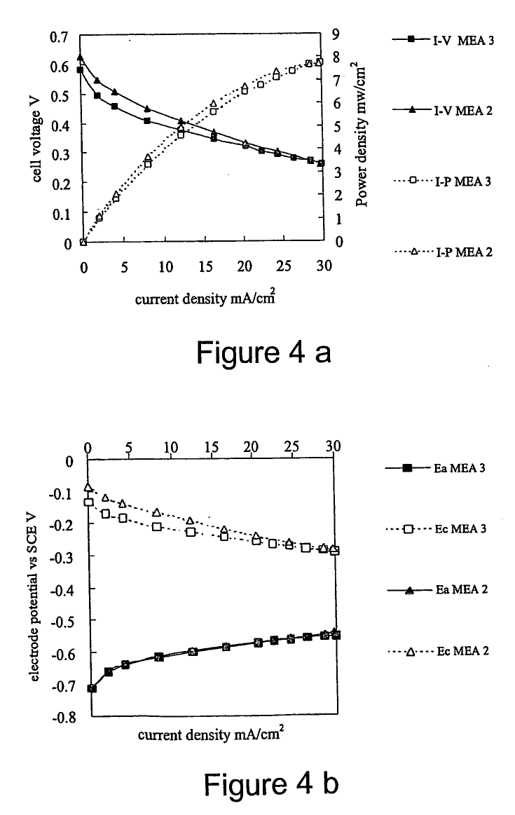

FIGS. 4a and 4b are graphs of the cell performance of two embodiments of the present invention at different fuel flow rates;

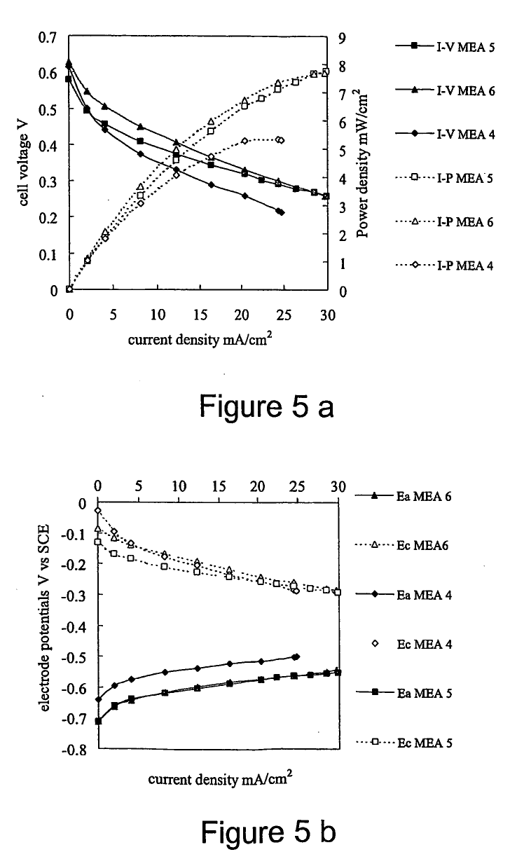

FIGS. 5a and 5b are graphs of the cell performance of three embodiments of the present invention at different fuel flow rates;

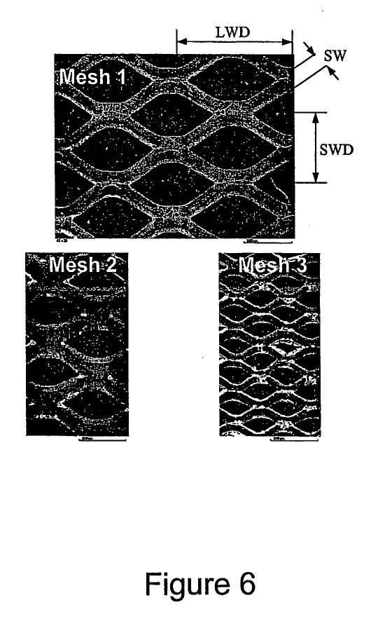

FIG. 6 shows SEM images of 3 Ti meshes according to the present invention;

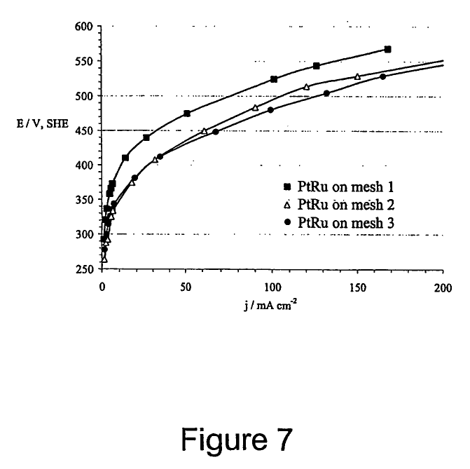

FIG. 7 shows the galvanostatic performance of three electrodes of the present invention in acid conditions;

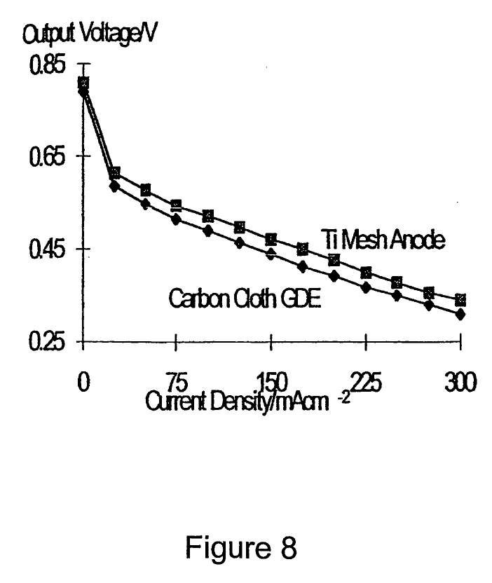

FIG. 8 shows cell voltage versus current density curves of two fuel cells of the present invention and a conventional fuel cell;

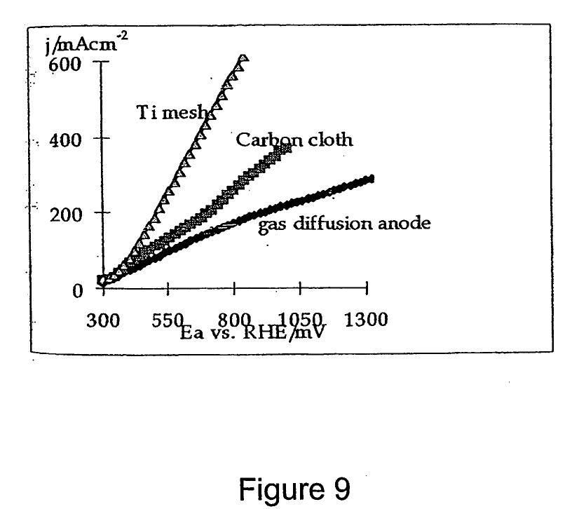

FIG. 9 is a graph comparing anodic polarization curves of a fuel cell of the present invention with known fuel cells; and

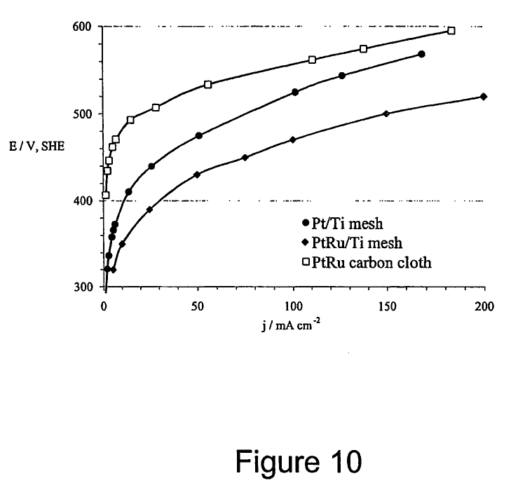

FIG. 10 is a graph comparing the galvanostatic polarization curves of fuel cells of the present invention with known fuel cells.

### DETAILED DESCRIPTION OF THE EMBODIMENTS

A conventional fuel cell is shown in FIG. 1. In this known arrangement, the fuel cell 1 is a divided cell and comprises an anode compartment 2 and a cathode compartment 3. A layered electrode structure 4 separates the anode and cathode compartments and comprises an anode structure 5, a membrane 6 and a cathode structure 7. The anode and cathode structures each comprise four layers: a catalyst layer 8,12 next to the membrane, a gas diffusion layer 9,13, a carbon paper or cloth 10,14 and a current collector 11,15 on the outer surface of the structure.

The membrane is permeable to water, gases and ions, but not electrons. The anode current collector 11 and the cathode current collector 15 are electrically connected by a circuit comprising a resistor 16 and an ammeter 17. The ammeter 17 allows the current produced by the fuel cell to be measured. A voltmeter 18 measures the potential difference across the resistor.

In use the conventional direct methanol liquid feed fuel cell generates an electric current by oxidising methanol. This is usually achieved by pumping an aqueous solution of methanol 20 into one end of the anode compartment causing it to flow over the anode structure 5. Air 21 is pumped into the cathode compartment and passes over the cathode structure 7. The two half-cell reactions (Ia) and (Ib) described above take place on the anode and cathode structures respectively. The membrane 6 transports water from the anode compartment 2 to the cathode catalyst layer 12. The carbon cloth 14 and gas diffusion layer 13 on the cathode side permit oxygen gas to reach the catalyst layer 12 and a reaction (Ib) between oxygen and water takes place. This reaction generates hydroxide ions which pass through the membrane to the anode, because of their negative charge.

Simultaneously, methanol reacts with hydroxide ions at the anode catalyst layer 8. This reaction (Ia) generates CO₂ which passes from the catalyst layer 8 to the anode compartment 2 through the gas diffusion layer 9 and carbon cloth 10.

The two half reactions generate a potential difference across the resistor in the circuit joining the anode and cathode structures. The resulting current in measured by the ammeter 17. The direction of current flow is from the anode to the cathode.

The reaction consumes methanol and oxygen and the products of the oxidation of methanol are CO₂ and water. Accordingly, a mixture 22 of unreacted methanol, water and CO₂ exits the anode compartment 2 and a mixture of oxygen-depleted air and water vapour 23 (from evaporation of water at the surface of the cathode structure) passes from the cathode compartment 3.

The carbon paper or cloth layers 10, 14 serve to allow access of the fuel to the catalyst and to collect current from the catalyst layer 8, 12. So, the anode carbon cloth 10 ensures that the electrons produced by the reaction of methanol and hydroxide ions at the anode catalyst layer 8 are transported to the current collector 11 so that a current can be established. Similarly, the cathode carbon cloth 14 ensures electrical contact between the cathode current collector 15 and cathode catalyst layer 12. The anode gas diffusion layer 9 allows CO₂ generated by the oxidation of methanol to escape into the aqueous solution in the anode compartment 2. The diffusion layers are made partially hydrophobic to enable gas flow whilst also allowing liquid flow in the nonhydrophobic regions. The flow of carbon dioxide gas and liquid fuel is counter current and hence both impede the other in the standard fuel cell configuration.

In use, the inventors have discovered that the CO₂ generated at the anode catalyst layer 8 builds up on the surface of the catalyst layer and in the membrane 6 because the carbon cloth 10 and gas diffusion layer 9 do not allow the CO₂ to efficiently diffuse away from the catalyst surface.

At its simplest, and apart from the electrode structure 4, the fuel cells of the present invention may be the same as the prior art arrangements previously described.

In a first embodiment of the present invention, the anode and cathode compartments are arranged in the same way as has been described with reference to FIG. 1 and will not be described in detail again. The same reference numerals are used to indicate corresponding parts.

FIG. 2 shows a first embodiment of the present invention and is a schematic representation of a direct methanol liquid feed fuel cell having an electrocatalyst coated metal mesh anode.

The mesh electrode arrangement comprises an anode structure, a membrane and a cathode structure. However, unlike known electrode structures the anode structure in this embodiment comprises a metal mesh 30 coated with an oxidation electrocatalyst. The mesh is a plurality of offset grids 40 arranged so that a tortuous through path exists across the width of the mesh. The mesh 30 has a strand size in the range 200−300 μm and the pore size is in the range 200−500 μm. A cross section 30 of the strand of the metal mesh can be seen in FIG. 2.

The mesh size is in the range 30−60 mesh. The mesh size is such that there is no restriction or resistance to the flow of a gas such as carbon dioxide from any point within the mesh to the anode compartment 2.

The metal core 31 of the strand provides the mesh with strength and rigidity. The outer layer 32 of the strand is the oxidation electrocatalyst, which may for example be Ru/Pt, which provides the active sites for catalysing the oxidation of methanol. The mesh 30 is joined directly to the membrane 6. On the cathode side of the membrane, the cathode structure is as described for known fuel cell arrangements. The mesh 30 is electrically connected to the cathode current collector layer 15 and the ammeter 17 measures the current generated between the mesh 30 and the cathode current collector layer 15.

In use, an aqueous methanol solution 20 passes over the mesh 30 and methanol is oxidised to carbon dioxide on catalyst material at or in the outer layer 32. The high surface area of the supported catalyst results in improved performance for this reaction. The CO₂ produced in this reaction is readily removed from the surface of the outer layer 32 and dispersed in the aqueous solution in the anode compartment 2 because the lattice structure of the mesh permits efficient mass transport of the gas away from the electrode surface and there are no intervening layers between the catalytic surface and the anode compartment 2, unlike prior art arrangements.

General Preparation Methods

Preparation of Electrode by Chemical Deposition

A Ti mesh anode with a Pt electrocatalyst was manufactured by chemical deposition. A Ti mesh surface was first abraded with emery paper and rinsed thoroughly with water. After drying, the Ti mesh was rinsed in acetone. Following etching with 20% HCl solution at 90° C. for 1 min, a catalyst slurry, comprising for example H₂PtCl₆+H₂O was painted onto the substrate. The resulting paint was applied as a thin layer followed by thermal decomposition in air within a cubic furnace at 350-500° C. for 20-60 minutes. The process was repeated about 10 times to build up the desired coating thickness.

Preparation of Electrode by Electrochemical Deposition

A Ti mesh anode with an electrocatalyst outer layer was manufactured by electrochemical deposition. Electrochemical deposition is a somewhat simpler procedure for producing catalyst coated electrodes, compared with chemical deposition techniques. A Ti mesh is pre-treated using the same method as that in the chemical deposition prior to mounting in an electrodeposition cell. The cell is filled with a N₂-saturated chloroplatinic acid and ruthenium chloride solution of known concentration and stirred mechanically. The catalyst is electrodeposited onto the substrate by selectively adjusting the potential. The amount of charge required to deposit the catalyst was monitored through a computer-controlled potentiostat. For co-electrodeposition of bimetallic deposits, e.g., Pt—Ru, a dual deposition strategy may be used, e.g. depositing Ru followed by depositing Pt or vice versa. After deposition of the catalyst material the electrodes were washed repeatedly with boiling Millipore conductivity water until free from any chloride content. Both chemical and electrochemical depositions were carried out with a number of electrodes under the same conditions to check the reproducibility of the technique. The platinum deposits obtained by the above procedure were bright and the ruthenium deposits tended to be dark grey in colour. The deposits appeared uniform to the eye and adhered quite strongly to the Ti mesh, requiring forceful scratching to remove them.

In one embodiment the Ti mesh was loaded with 2 mg Pt and 1 mg Ru/cm². An SEM study of the Pt—Ru/Ti mesh indicated that the Pt and Ru particles were distributed homogeneously across the matrix as a dense granular microstructure, although macropores or defects existed on the surface. The electrode showed significant phase segregation and discrete regions of substrate and Pt—Ru particles. Small particles were deposited among the large particles. The particle size ranges from several nanometers to 200 nm. Some bigger clusters (up to 1.5 μm in diameter), produced by aggregation of smaller grains, were observed. Consequently, there were a great number of boundaries or interfaces between Pt and Ru particles of different sizes, which form a stack microstructure of catalyst particles and result in a very rough surface of the electrodeposited layer. All of these features contribute to a very high effective surface area of the electrode, which is an important factor in achieving high catalytic activity in this type of electrode.

Preparation of Electrode by Thermal Decomposition

A thermal decomposition method was applied to directly deposit catalyst on titanium minimesh (1×1 cm). Prior to coating, the mesh was etched in 10% oxalic acid at 80° C. for one hour to achieve better anchorage; it was then thoroughly rinsed with distilled water. To apply a catalyst layer the etched substrate was dipped into a precursor (e.g. 0.2 M metal chloride in isopropanol). After each dip the sample was manipulated, gently swirled to form a uniform coating which was then dried. In this way a mass of about 0.2 mg (nominal thickness of 0.07 μm) coating on 1 cm² substrate could be applied from each dipping and a catalyst loading of approximately 1 mgcm⁻² catalyst was obtained from 5 dips. Calcination was then performed in air at 400° C. for 1 h. The electrodes fabricated in this way were designated Pt/Ti and PtRu/Ti (Pt:Ru=0.5:0.5 in atomic ratio).

Preparation of Ti Mesh Electrode Assembly

In one embodiment an electrocatalyst coated Ti mesh MEA was obtained by hot pressing an anode and a cathode on either side of a pre-treated Nafion 117 membrane at a pressure of 100 kg cm⁻² and temperature of 125° C. for 3 minutes. The membrane pre-treatment involved boiling the membrane for 1 hr in 5 volt % H₂O₂ and 1 hr in 1 M sulphuric acid before washing in boiling Millipore water (>18 mΩ) for 2 hrs with regular changes of water. The thickness of the MEA is approximately 1 mm.

### EXAMPLES

### Example 1

### Operation of Membrane Electrode Assembly

The following MEAs were prepared:

| MEA | Anode | Formed by | Cathode | Formed by |
|---|---|---|---|---|
| 1 | PtRu Ti mesh 3 | Thermal | Pt | Chemical |
| | (1:1 1.5 mgcm⁻²) | deposition | (0.4 mgcm⁻²) | deposition |
| 2 | PtRu Ti mesh 3 | Thermal | Pt on ADP | Chemical |
| | (1:1 1.5 mgcm⁻²) | deposition | membrane | deposition |
| | | | (1.1 mgcm⁻²) | |
| 3 | PtRu Ti mesh 3 | Thermal | Pt | Chemical |
| | (1:1 1.5 mgcm⁻²) | deposition | (0.4 mgcm⁻²) | deposition |
| 4 | Pt | Chemical | Pt | Chemical |
| | (0.645 mgcm⁻²) | deposition | (0.7 mgcm⁻²) | deposition |
| 5 | PtRu Ti mesh 3 | Thermal | Pt | Chemical |
| | (1:1 1.5 mgcm⁻²) | deposition | (0.4 mgcm⁻²) | deposition |
| 6 | PtRu Ti mesh 3 | Thermal | Pt | Chemical |
| | (1:1 1.5 mgcm⁻²) | deposition | (1.1 mgcm⁻²) | deposition |

The MEAs were conditioned for 48 hrs in a test fuel cell at 75° C. and atmospheric pressure with a continuous feed of 2 M methanol. The MEAs were then tested in an alkaline fuel cell at different conditions to ascertain reproducibility of their performance.

The alkaline fuel cell uses methanol as a fuel in an alkaline sodium hydroxide solution. The structure of the fuel cell is as described with reference to FIG. 2, except that the cathode is a high surface area porous catalytic electrode, and the electrolyte membrane 6 is a polymer ion exchange membrane which preferentially transfers sodium ions from the anode side to the cathode side of the cell. In the cathode side of the cell oxygen is reduced to hydroxide ions which combine with the sodium ions to form an alkaline solution.

CO₂ generated at the anode combines with the sodium hydroxide to produce sodium carbonate or bicarbonate. The carbonate or bicarbonate can be re-converted back to hydroxide, by for example the addition of hydrogen ions, which would liberate the CO₂.

The movement of sodium ions through the membrane will also cause water to be transferred in the same direction. Every mole of methanol oxidised will cause the transfer of six moles of Na⁺ ions.

The fuel cell tests used a 2M MeOH solution in 1M NaOH at 2 bar and 60°C., and at two methanol flow rates: 5.6 ml min⁻¹ and 60.6 ml min⁻¹. The results of the tests are shown in FIGS. 3 to 5.

FIG. 3a shows the cell voltage vs current density (I-V) and power density vs current density (I-P) curves for MEA 1, operating at 5.6 and 60.6 ml min⁻¹ MeOH flow rate. This figure shows that the fuel cells of the present invention operate over a wide range of flow rates and generate high current density at low potentials, and that at elevated flow rates the power density rises steadily with the current density.

FIG. 3b shows anode (Ea) and cathode (Ec) potentials vs current density curves for MEA 1 at a MeOH flow rate of 5.6 and 60.6 ml min⁻¹.

FIG. 4a shows cell voltage vs current density (I-V) and power density vs current density (I-P) curves for MEA 2 and 3, operating at a MeOH flow rate of 60.6 ml min⁻¹.

FIG. 4b shows anode (Ea) and cathode (Ec) potential vs current density curves for MEA 2 and 3, operating at a MeOH flow rate of 60.6 ml min⁻¹.

FIG. 5a shows cell voltage vs current density (I-V) and power density vs current density (I-P) curves for MEAs 4 to 6, operating at a MeOH flow rate of 60.6 ml min⁻¹.

FIG. 5b shows anode (Ea) and cathode (Ec) potential vs current density curves for MEAs 4 to 6, operating at a MeOH flow rate of 60.6 ml min⁻¹.

The results show that electrodes of the present invention are robust and maintain their structure even after extended use, and that there was no damage to the electrodes resulting from their use in methanol oxidation.

### Example 2

### Effect of Mesh Structure on Performance

Three mesh electrodes having a rhombus pore shape and each having a different pore size and strand width were prepared using the thermal decomposition method described above and are shown in FIG. 6. The Ti mesh electrodes were coated with PtRu (Pt:Ru=0.5:0.5 in atomic ratio). The geometric parameters of the three mesh electrodes are listed as in Table 1, and SEM images of the meshes are shown in FIG. 6. The pore size dimensions LWD and SWD are illustrated in FIG. 6 and correspond to the long and short dimensions of the rhombus pores.

TABLE 1

| Parameters | Mesh 1 | Mesh 2 | Mesh 3 |
|---|---|---|---|
| Pore size | | | |
| LWD/mm | 1.28 | 1 | 0.52 |
| SWD/mm | 0.72 | 0.64 | 0.36 |
| Strand width/mm | 0.14 | 0.18 | 0.08 |

FIG. 7 shows the galvanostatic performance of the different electrodes in 2 M MeOH+0.5 M H₂SO₄ at 60° C. The galvanstatic performance of an electrode is a measure of the steady state current density as a function of electrode potential. The PtRu catalyst thermally deposited on Ti mesh 3 possesses the highest catalytic activity with the lowest polarised potential, about 470 mV, at a current of 100 mA cm⁻², 40 mV lower than that of mesh 1. A slightly lower catalytic activity than that of Mesh 3 was observed when using Mesh 2. Without wishing to be bound by theory, the effect of mesh structure on the catalytic activity is attributed to the different opening area of the mesh supports.

### Example 3

### Comparison of Conventional Fuel Cell with Ti Mesh Fuel Cell

A fuel cell according to the present invention comprising an electrocatalyst coated Ti mesh was compared with a conventional fuel cell comprising a carbon cloth electrode gas diffusion electrode.

FIG. 8 shows two cell voltage versus current density curves obtained from a flow DMFC operating with two anode structures: a Pt—Ru/Ti mesh anode according to the present invention made by thermal deposition, and a conventional Teflon bonded carbon cloth gas diffusion anode. Each has a catalyst loading of 2 mg Pt+1 mg Ru cm⁻². The cathode was a conventional carbon cloth arrangement in both cells. FIG. 8 was obtained by flowing a 2 M methanol solution at 90° C. to the anodic chamber and by passing 1.5 bar air into the cathodic chamber, and recording the cell performance with each of the anode structures.

The anode structure according to the present invention comprises a membrane electrode assembly comprising a PtRu coated Ti mesh made by thermal decomposition of metal chloride precursor hot pressed. to a pre-treated Nafion 117 membrane at a pressure of 100 kgCm⁻² and temperature of 125° C. for 3 minutes, as described above. The conventional carbon cloth gas diffusion anode (and the cathode used with both anodes) were prepared by the following procedure:

20 wt % Pt and 10 wt % Ru on Vulcan XC-72R carbon (Electrochem. Inc, USA) was used to prepare Pt—Ru and Pt catalysts. Each of the conventional electrodes comprises a backing layer, a gas diffusion layer and a reaction layer. A teflonised carbon cloth (E-TEK, type A) of 0.35 mm thickness was employed as the backing layer. To prepare the gas diffusion layer, isopropanol was added to a pre-teflonised Ketjen Black carbon to make a paste. The resulting paste was spread onto the carbon cloth and dried in an air oven at 85° C. for 5 to 15 minutes. To prepare the reaction layer, the required quantity of Pt—Ru/C (anode) or Pt/C (cathode) was mixed with 10 wt % teflonised carbon. A quantity of Nafion solution was added to the mixture with continuous stirring. The resulting paste was spread onto the gas diffusion layer of the electrode and dried in an air oven at 85° C. for five minutes. The catalyst content on the anode was maintained at a level of 2 mg Pt cm⁻² while that on the cathode was 1 mg Pt cm⁻². Finally, a thin layer of Nafion solution was spread onto the surface of each electrode.

The conventional sandwiched membrane electrode assembly comprising the gas diffusion electrode was obtained by hot pressing the anode and cathode on either side of a pre-treated Nafion 117 membrane at 100 kg cm⁻² and 125° C. for 3 minutes. The membrane pre-treatment involved boiling the membrane for 1 hr. in 5 vol % H₂O₂ and 1 hr in 1 M sulphuric acid before washing in boiling Millipore water (>18 mΩ) for 2 hrs with regular changes of water. The thickness of the MEA is approximately 0.8 mm depending on the diffusion layer thickness.

The resulting conventional and PtRu Ti mesh anode membrane electrode assemblies were housed between two graphite blocks, in which parallel channel flow paths cut out for methanol and oxygen/air flow, using a set of retaining bolts positioned around the periphery of the cell. Both electrodes were contacted on their rear with gas/liquid flow field plates machined from impregnated high density graphite blocks in which channels were formed. The ribs between the channels make the electrical contact to the back of the electrodes and conduct the current to the external circuit. Electrical heaters were placed behind each of the graphite blocks to heat the cell to the desired operational temperature. The graphite blocks were also provided with electrical contacts and small holes to accommodate thermocouples. The fuel cells were used in a simple flow rig, which consisted of a perilstatic pump to supply aqueous methanol solution, from a reservoir, and a temperature controller to heat the methanol. Oxygen or air was supplied from the cylinders at ambient temperature, and the pressure regulated at an inlet by pressure regulating valves. All connections between the cells and equipment were with PTFE tubing, fittings and valves. The MEA was hydrated with water circulated over the anode at 75° C. for 48 hrs. After allowing 48 hrs to condition a new MEA in the test fuel cell at 75° C. and atmospheric pressure with continuous feed of 2 M methanol, the galvanostatic polarisation data were obtained at various operating conditions. Several MEAs were tested to ascertain reproducibility of the data.

The flow fuel cell with the PtRu coated Ti mesh anode delivered higher power density (102 mW cm⁻²) compared with the same cell when operating with a conventional carbon cloth gas diffusion anode (93 mW cm⁻²) (not shown), at potentials near 0.3V at 90° C.

The results in FIG. 8 show that an improvement in the output cell voltage of about 30 mV can be achieved at all current densities by using the PtRu coated Ti mesh anode of the present invention rather than a conventional carbon supported gas diffusion anode.

### Example 4

### Comparison of Pt/Ru coated Mini-Mesh Electrodes with Carbon Cloth Electrodes

FIG. 9 shows the polarisation curves obtained with three tyes of electrode in the oxidation of MeOH from a solution of 1M MeOH+0.5M H₂SO₄ at 60° C. The cathode comprises a Pt (2 mgcm⁻²) coated Ti mesh in all cases. The anode comprises Pt (2 mgcm⁻²) and Ru (1 mgcm⁻²) and the three structures are i) PtRu electrodeposited on Ti mesh, ii) PtRu electrodeposited on carbon cloth, and iii) PtRu gas diffusion electrode.

FIG. 9 was obtained during methanol oxidation using a mesh, a carbon cloth or a carbon powder electrode with a catalyst loading of 2 mg Pt+1 mg Ru cm⁻² in 1 M CH₃OH+0.5 M H₂SO₄ solution at 80° C. The methods of electrode preparation were as described above.

Experimental data shown in FIG. 9 shows that a Pt/Ru coated mini-mesh gives superior performance than carbon cloth based electrodes. The electrodes can function in acid, neutral and alkaline electrolytes as well as without a liquid based electrolyte.

These results also show that a Pt—Ru coated Ti mini-mesh anode has improved anode polarisation compared with carbon supported catalysts in the DMFC. Results for the mini-mesh design also indicate the absence of mass transport limitations during methanol oxidation.

The high efficiency of Pt—Ru/Ti mesh anodes of the present invention for methanol oxidation has been demonstrated by potential reductions of several hundred mV at a current density of 200 mA cm⁻². The catalyst coated Ti mesh electrode provides micropores for gas and liquid access, and conductive paths for electron access. The problems of conventional carbon supported electrodes, such as high ohmic losses and low ionic conductivities, are overcome to a large extent by the electrocatalyst coated Ti mesh electrode of the present invention.

### Example 5

### Comparison of Pt Coated and PtRu coated Ti Mini-Mesh Electrodes with Carbon Cloth Supported PtRu Electrodes

FIG. 10 compares the galvanostatic polarization behaviour of Pt and PtRu coated Ti mesh electrodes with conventional PtRu carbon cloth based electrodes (1.5 mg loading with a ratio of Pt:Ru=1:0.5). The data presented are galvanostatic polarisation plots in 2M MeOH+0.5MH₂SO₄ at 60° C. on catalysts thermally formed in air at 400° C. The data clearly shows that the activity of the catalysts coated on the titanium mesh is superior to one of the most active known carbon supported catalysts. In addition the data also shows that the onset potential of methanol oxidation on PtRu/Ti is 100 mV lower than that on Pt/Ti, indicating that there is a significant additional performance advantage associated with the PtRu electrocatalyst in combination with the Ti mesh electrode.

1. A fuel cell having an anode, a cathode and an electrolyte which is an ion exchange membrane, wherein the anode and cathode are immediately adjacent the electrolyte and wherein the anode comprises an electrocatalyst on a support which is a mesh of conductive material.

2.-4. (canceled)

5. A fuel cell according to claim 1, wherein the electrocatalyst is a metal, metal alloy, metal oxide or metal hydride.

6. A fuel cell according to claim 1, wherein the mesh has a minimum pore size of 5 μm.

7. A fuel cell according to claim 1, wherein the mesh has a minimum pore size of 50 μm.

8. A fuel cell according to claim 1, wherein the mesh comprises a plurality of layers.

9. A fuel cell according to claim 8, wherein adjacent layers of the mesh are orientated at an angle to one another.

10. A fuel cell according to claim 1, wherein the mesh is made of a conductive material selected from metal, metal alloy and metal composite.

11. A fuel cell according to claim 10, wherein the mesh is made from titanium or titanium alloy.

12. A fuel cell according to claim 1, wherein there is at least one intermediate layer between the electrocatalyst and the mesh.

13. A method of operating a fuel cell according to claim 1, comprising the step of contacting a fuel and an oxidant on said anode comprising an electrocatalyst supported on a mesh of conductive material.

14. The use of a membrane electrode assembly comprising an anode a cathode and an electrolyte which is an ion exchange membrane, wherein the anode and cathode are immediately adjacent the electrolyte and wherein the anode comprises an electrocatalyst supported on a mesh of conductive material in a fuel cell.
